(19) United States
(12) Patent Application Publication
(10) Pub. No.: US 2003/0079573 A1
(43) Pub. Date: May 1, 2003

(54) Pivoting dual socket adaptor

(76) Inventor: J. B. Spearman, Irvington, NJ (US)

Correspondence Address: Paul Gauer, Attorney at Law, 347 Franklin Street, Bloomfield, NJ, 07003, US

(21) Appl. No.: 09/917,422

(22) Filed: Jul. 30, 2001

(51) Int. Cl. B25B 13/00

(52) U.S. Cl. 81/124.5

(57) ABSTRACT

A dual size adaptor for use in connection with an air gun, ratchet or drill with a holder having a pivot arm for reversing different size/types screwdriver heads, drill bits or sockets.

This invention relates generally to tools and more particularly to socket adaptors

### BACKGROUND ART

Various types of tools use socket adaptors with each adaptor particularly sized to correspond to the desired hole or nut size. When performing tasks it is desirable that the tool operator has ability to switch adaptor sizes rapidly. Some previous inventors have attempted to fulfill this need.

U.S. Pat. No. 5,168,782 to Cromwell filed Apr. 1, 1991 describes a tool extension adaptor for attaching two different sized tools, such as a socket wrench to an air gun, by reversing the adaptor.

U.S. Pat. No. 5,752,418 to Robins filed Jan. 3, 1997 displays a dual sized adaptor for a socket wrench capable of projecting or telescoping alternative sized ends.

Neither of these inventors have applied the pivoting concept for switching adaptor sizes.

### OBJECTS OF INVENTION

An object of this invention is to provide a dual sized socket adaptor whose size is easily changed by swiveling 180 degrees about a pivot.

A further object of this invention is to produce a socket adaptor with ability to rapidly interchange two different bits whose use would save time and labor.

Still another object of the invention is to allow flexibility in socket adaptor use without sacrificing the strength and torque associated with a hardened tempered steel socket drive shaft.

### SUMMARY OF INVENTION

A socket adaptor incorporating a built in, two headed bit that can be reversed by pivoting the bit 180 degrees enabling the user to choose either of two bits without having to remove the socket as required with conventional socket wrenches. The bit head is reversible with a specific size socket or bit on one end and a different size on its opposite end. For example, one end might be adapted to 9/16 inch with opposite end fitted for ¾ inch. Combination of other commonly used socket sizes and screwdriver bits etc. would be available.

### DESCRIPTION OF DRAWINGS

FIG. 1A cross section view

FIG. 1B cross section view with pivot arm swindled

FIG. 2 front view

FIG. 3 side view

FIG. 4 side view

FIG. 5 side view

FIG. 6 front view

### DESCRIPTION OF PREFERRED EMBODIMENT

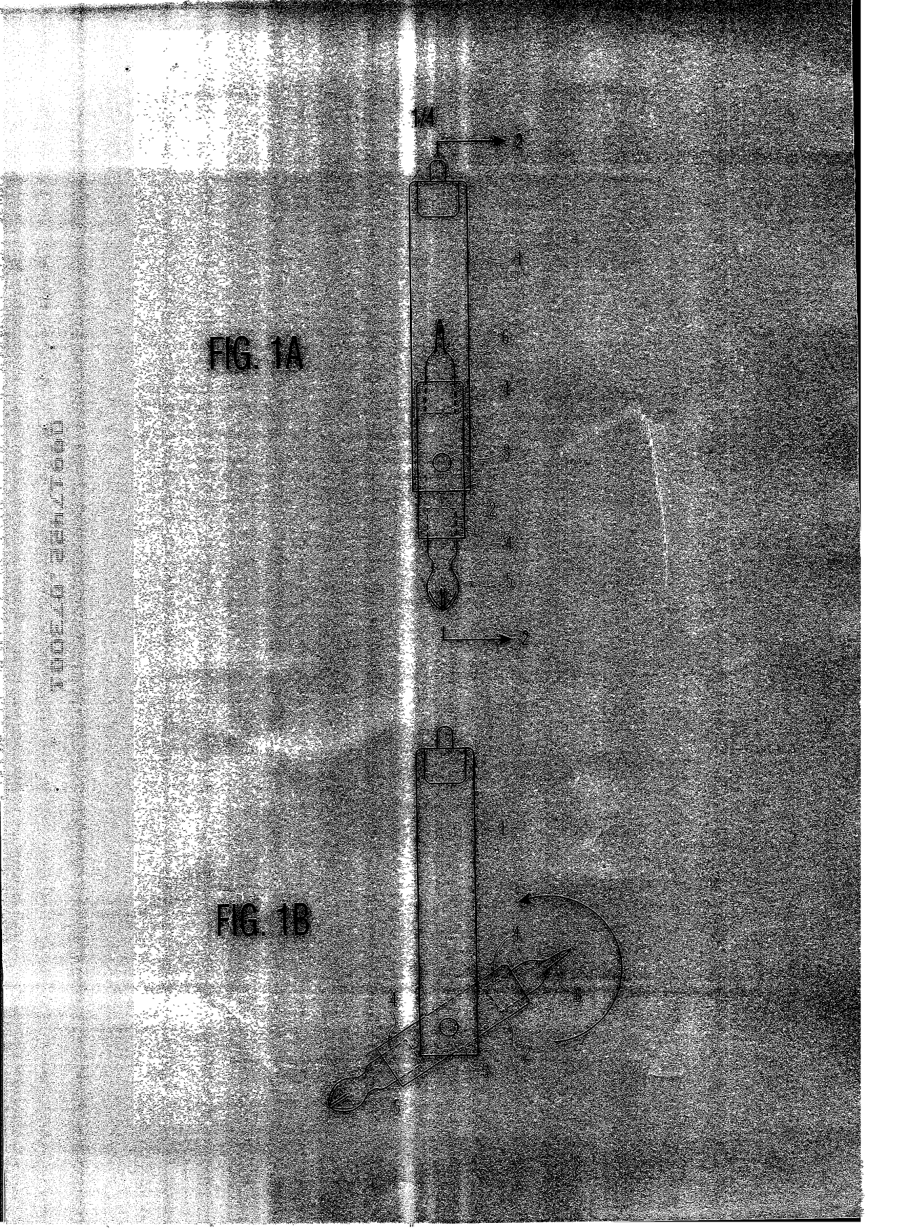

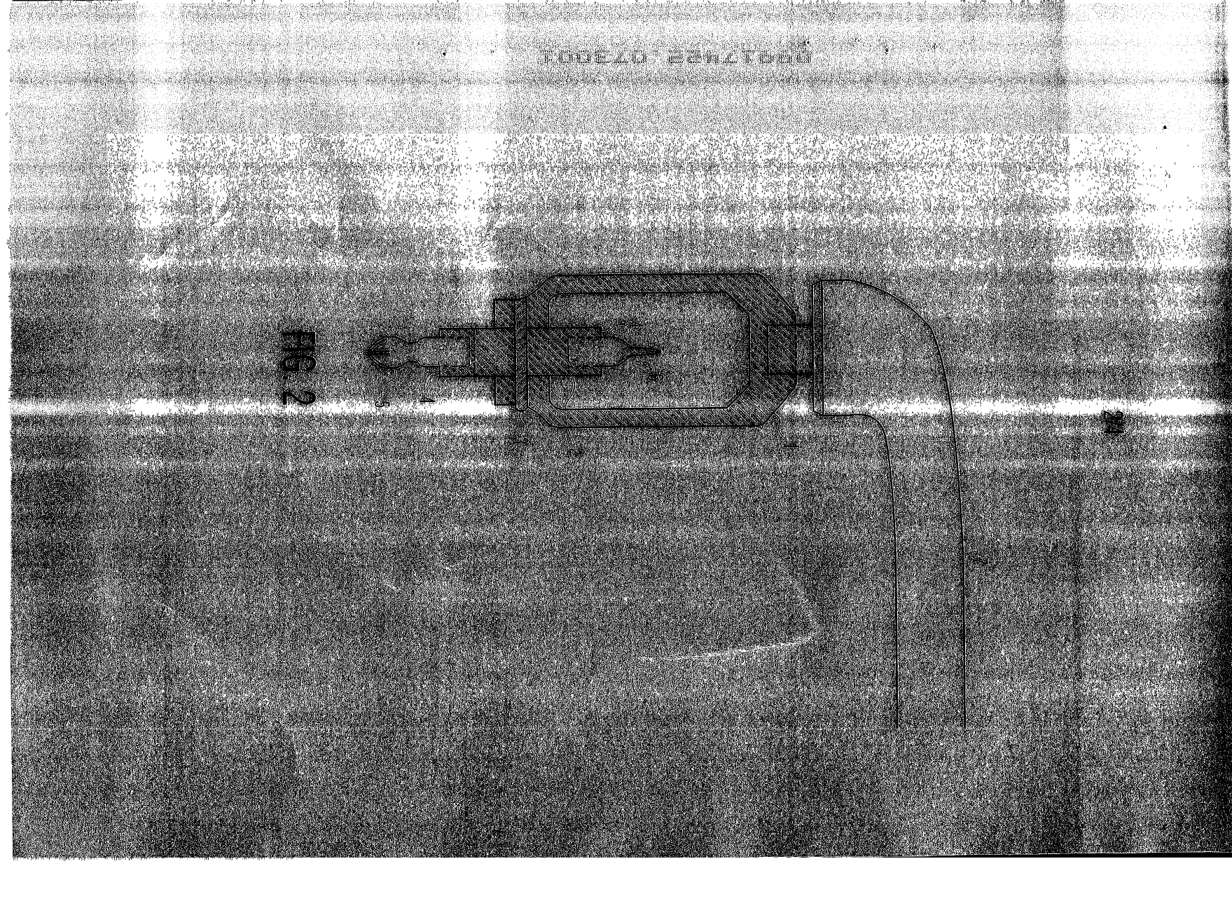

In FIG. 1A the holder (1) supports a pivot arm (2) along a pivot axis (3). The pivot arm (2) has 2 pivot arm sockets (4) at its opposite ends. In this example one pivot arm socket (4) contains a phillips screwdriver head (5) and the other pivot arm socket (4) contains a common screwdriver head (6).

In FIG. 1B the pivot arm (2) is in a swiveled position.

In FIG. 2 the holder (1) is attached to an air gun (7) (which is interchangeable with a ratchet or drill) and supports the pivot arm (2) along the pivot axis (3). The pivot arm (2) has 2 pivot arm sockets (4) at its opposite ends. In this example one pivot arm socket (4) contains a phillips screwdriver head (5) and the other pivot arm socket (4) contains a common screwdriver head (6).

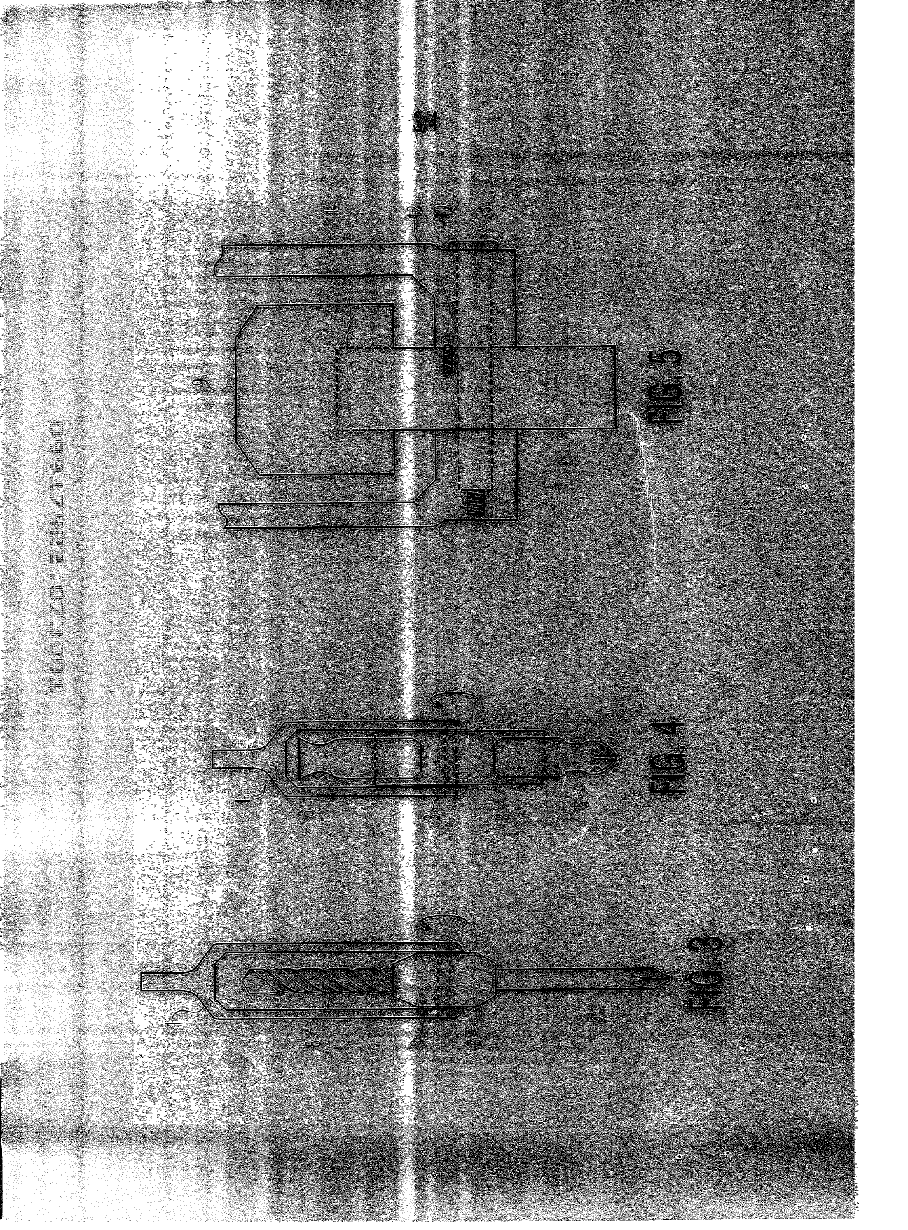

In FIG. 3 the holder (1) supports the pivot arm (2) along the pivot axis (3). The pivot arm (2) has 2 pivot arm sockets (4) at its opposite ends. In this example one pivot arm socket (4) contains a phillips screwdriver head (5) and the opposite pivot arm socket (4) contains a drill bit (8).

In FIG. 4 the holder (1) supports a pivot arm (2) along a pivot axis (3). The pivot arm (2) has 2 pivot arm sockets (4) at its opposite ends. In this example one pivot arm socket (4) contains a phillips screwdriver head (5) and the opposite end pivot arm socket has a common screwdriver head (6).

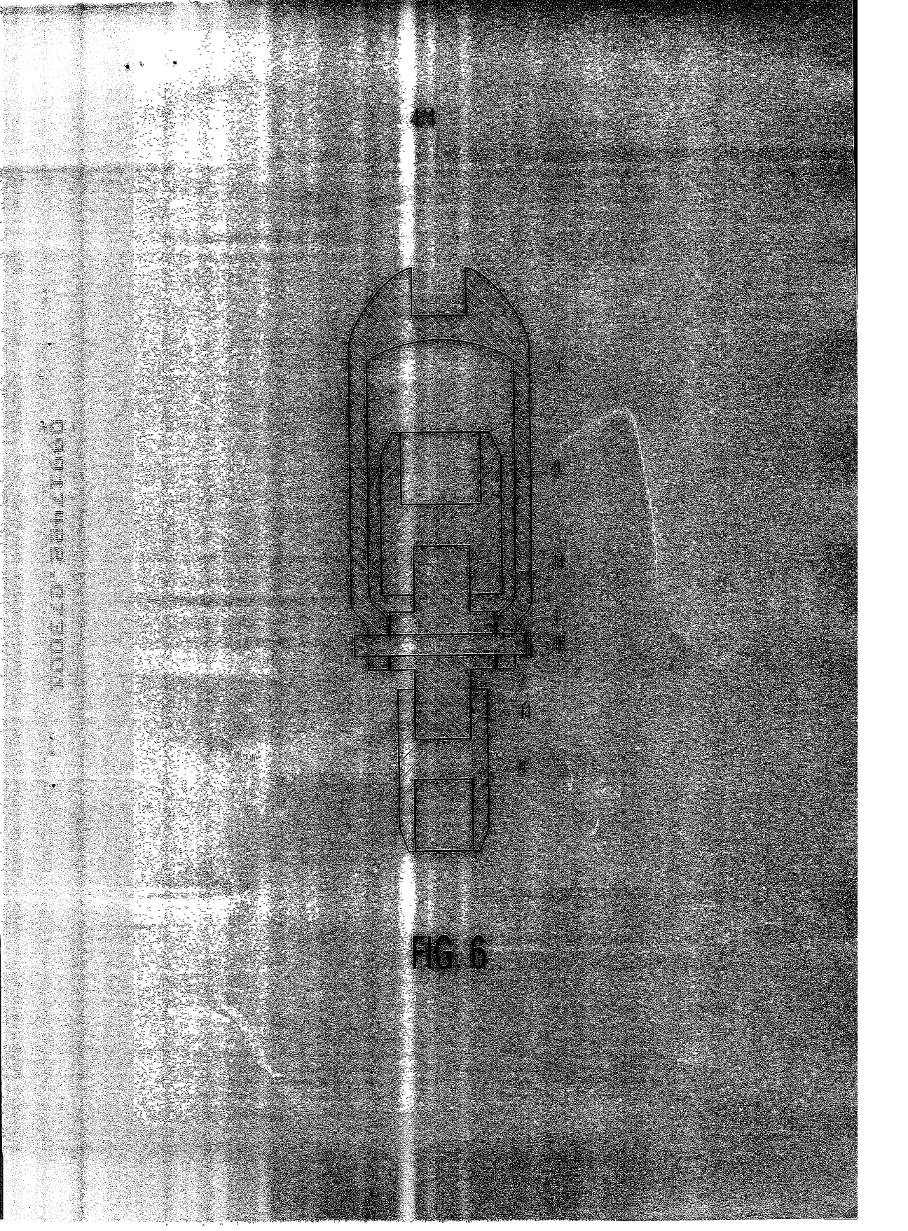

In FIG. 5 the holder (1) supports a pivot arm (2) along a pivot axis (3). In this case, the pivot axis (3) is of a screw headed type (10). Instead of a pivot arm socket (4) this pivot arm has male extender (11) for receipt of standard socket (9). Also shown is a pin (12) to lock the pivot arm (2) in place.

In FIG. 6 the holder (1) supports a pivot arm (2) about a pivot axis (3) having a screw head (10). This pivot axis (2) has 2 male extenders (11) at opposite ends each for acceptance of a standard socket (9)

The inventor claims:

1. A dual size socket adapter for use in combination with an air gun, ratchet or drill comprising:
a holder, which supports a pivot arm along a pivot axis,
a pivot arm with 2 sockets at opposite ends for receipt of alternate screwdriver heads or drill bits.

2. The adaptor of claim 1 wherein a pin is used to lock the pivot arm in place.

3. The adaptor of claim wherein the pivot arm has a male extender at either or both ends instead of a socket for receipt of a socket.

4. The adaptor of claim 3 wherein a pin is used to lock the pivot arm in place.
